(19) United States
(12) Patent Application Publication
(10) Pub. No.: US 2012/0155461 A1
(43) Pub. Date: Jun. 21, 2012

(54) APPARATUS FOR MANAGING VIRTUAL NETWORK

(75) Inventors: Doyeon Kim, Daejeon (KR); Jae Gi Lee, Daejeon (KR); Taesang Choi, Daejeon (KR)

(73) Assignee: Electronics and Telecommunications Research Institute, Daejeon (KR)

(21) Appl. No.: 13/289,748

(22) Filed: Nov. 4, 2011

(30) Foreign Application Priority Data
Dec. 16, 2010 (KR) 10-2010-0129401
May 30, 2011 (KR) 10-2011-0051623

(51) Int. Cl. H04L 12/56

(52) U.S. Cl. 370/389

(57) ABSTRACT

An apparatus for managing a virtual network perform functions of a control plane and a management plane of a network element, including a plurality of forwarding elements forwarding packets, by a control management system, implemented separately from a network element.

### CROSS-REFERENCE TO RELATED APPLICATION

This application claims priority to and the benefit of Korean Patent Application Nos. 10-2010-0129401 and 1 0-201 1-0051 623 filed in the Korean Intellectual Property Office on Dec. 16, 2010 and May 30, 2011, the entire contents of which are incorporated herein by reference.

### BACKGROUND OF THE INVENTION

(a) Field of the Invention

The present invention relates to an apparatus for managing a virtual network. More particularly, the present invention relates to an apparatus for managing network equipment where a data plane, a control plane, and a management plane are separated.

(b) Description of the Related Art

In the current Internet, data and control planes are integrated. For this reason, operations, such as adding or changing functions or expanding a network scale, totally depend upon associated network equipment providers. This makes it difficult to reflect the management policy of a network operator. To address this issue, it is required to separate control, data and management planes.

Furthermore, the research into the virtualization of network resources, which is one of primary characteristics of the future Internet, is actively ongoing to overcome the limitations of the current Internet. Therefore, a method for supporting the virtualization of network resources in a structure where a control plane, a data plane, and a management place are separated is also in need.

### SUMMARY OF THE INVENTION

The present invention has been made in an effort to provide an apparatus for managing a virtual network having advantages of supporting the virtualization of network resources in a structure where a control plane, a data plane, and a management plane are separated.

An exemplary embodiment of the present invention provides an apparatus for managing a virtual network. The apparatus for managing a virtual network includes a network element performing a virtual routing function; and a control management system performing functions of a control plane and a management plane of the network element, and separated from the network element.

The network element may include: a plurality of forwarding elements forwarding a packet; a control element agent controlling the plurality of forwarding elements through communication with the control management system; a management element agent managing the plurality of forwarding elements through communication with the control management system; and a virtualization switch virtualizing and switching a packet received through the control management system, and virtualizing and switching a packet received from the plurality of forwarding elements.

Another embodiment of the present invention provides an apparatus for managing a virtual network including: a plurality of forwarding elements forwarding a packet; a physical layer interface part for communication with a control management system performing functions of a control plane and a management plane of a network element; a control element agent controlling the plurality of forwarding elements through a control element generated by the control management system; and a management element agent managing the plurality of forwarding elements through a management element generated by the control management system.

### BRIEF DESCRIPTION OF THE DRAWINGS

FIG. 1 is a view illustrating an apparatus for managing a virtual network according to an exemplary embodiment of the present invention.

FIG. 2 is a view illustrating a network element depicted in FIG. 1.

FIG. 3 is a view illustrating a virtualization switch depicted in FIG. 2.

FIG. 4 is a view illustrating a forwarding element depicted in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification and claims, unless explicitly described to the contrary, the word “comprise” and variations such as “comprises” or “comprising”, will be understood to imply the inclusion of stated elements but not the exclusion of any other elements.

Hereinafter, an apparatus for managing a virtual network according to an exemplary embodiment of the present invention will be described in more detail.

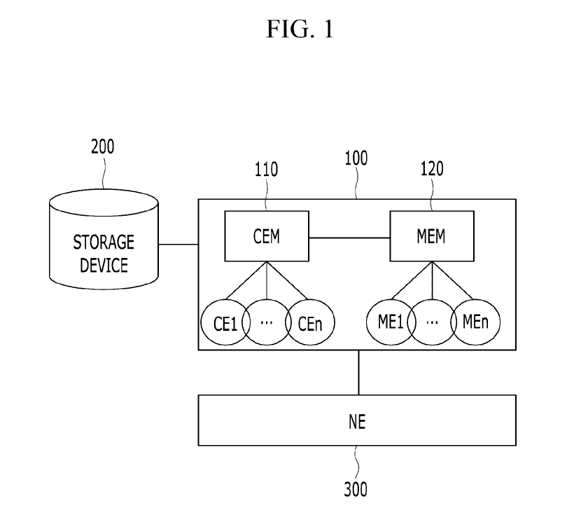

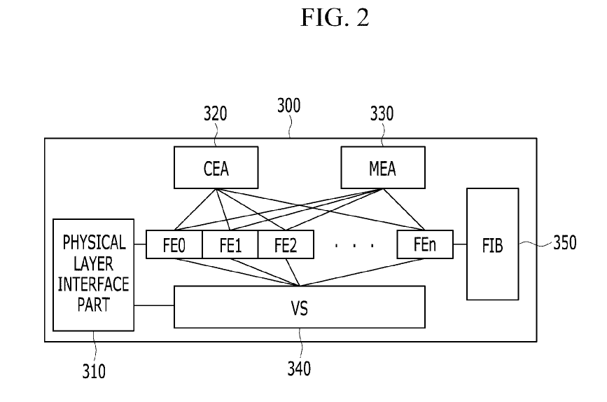

FIG. 1 is a view illustrating an apparatus for managing a virtual network according to an exemplary embodiment of the present invention, and FIG. 2 is a view illustrating a network device depicted in FIG. 1.

Referring to FIG. 1, an apparatus for managing a virtual network includes a control management system (CMS) 100, a storage device 200, and a network element (NE) 300.

The CMS 100 performs the functions of a control plane and a management plane of the NE 300 by referring to information stored in the storage device 200. The CMS 100 includes a control element manager (CEM) 110, and a management element manager (MEM) 120.

FIG. 1 illustrates a logical structure, and in actual implementation, the CMS 100 and the NE 300 may be separately configured. In particular occasions, the functions of the CMS 100 may be implemented in the form of using a part of the core of a network process within the same equipment. In a case where the CMS 100 and the NE 300 are separately configured, communication between the CMS 100 and the NE 300 may be carried out by a Layer 2 scheme. In a case where the functions of the CMS 100 are implemented by using a part of the core of a network processor within the same equipment, communication between the CMS 100 and the NE 300 may be carried out by using a system bus.

The CEM 110 manages one or more control elements CE1 to CEn, and the MEM manages one or ore management elements ME1 to MEn.

In detail, the CEM 110 may generate, change, and delete the control elements CE1 to CEn, and performs functions to manage status and mapping information of the control elements CE1 to CEn and provide an interface with the MEM 120 and with the storage device 200.

The MEM 120 may generate, change, and delete the management elements ME1 to MEn, and performs functions to manage status and mapping information of the management elements ME1 to MEn and provide an interface with the CEM 110 and with the storage device 200.

The control elements CE1 to CEn execute, by the CEM 110, network control functions associated with, for example, a routing protocol such as a Routing Information Protocol (RIP), an Open Shortest Path First (OSPF) protocol, an Intermediate System to Intermediate System (IS-IS) protocol, and a Border Gateway Protocol (BGP), a signaling protocol such as a Generalized Multiprotocol Label Switching (GMPLS) protocol, a Constraint-based Routing

Label Distribution Protocol (CR-LDP), and a Resource Reservation Protocol (RSVP), or the like. The management elements ME1 to MEn perform, by the MEM 120, network management functions, such as the configuration management, monitoring, failure and traffic management of the management elements ME1 to MEn, the management of virtual resources such as an interface and routing paths, and other functions which may be defined by a user.

The storage device 200 stores network topology, routing paths, and network resources.

The NE 300 is a network device such as a router, a switch or the like, and performs functions as a virtual router.

That is, the apparatus for managing a virtual network according to an exemplary embodiment of the present invention separates control and management planes from the NE 300. Then, the CEM 110 in the separated control plane performs control plane functions such routing-path calculation while reflecting a management policy desired by a network operator. The result thereof is set in the NE 300 by using a communication protocol. Referring to FIG. 2, the NE 300 includes a physical layer interface part 310, a control element agent (CEA) 320, a management element agent (MEA) 330, a virtualization switch (VS) 340, forwarding elements FE0 to FEn, and a forwarding information database (FIB) 350.

The physical layer interface part 310 provides connection to an external network.

The CEA 320 controls the forwarding elements FE0 to FEn for routing, signaling and the operation of another control protocol defined by a user through communication with the CEM 110.

Through communication with the MEM 120, the MEA 330 manages the forwarding elements FE0 to FEn to manage the configuration setting, monitoring, failure and traffic management of the management elements ME1 to MEn, the management of virtual resources, another function which may be defined by a user, and the like.

The forwarding elements FE0-FEn forward packets according to information in the FIB 350 and a virtual interface.

The VS 340 virtualizes packets transmitted/received through the physical layer interface part 310 and switches the packets. The VS 340 virtualizes packets received through the CEM 110 and the MEM 120, and switches the packets to the corresponding forwarding elements FE0 to FEn. Also, the VS 340 virtualizes packets received from the forwarding elements FE0 to FEn and switches the packets to the CEM 110 and/or the MEM 120.

The FIB 350 stores packet forwarding information, and the packet forwarding information may be generated or updated according to the operation of the control functions of the CEM 110 and the CEA 320.

The NE 300 may be implemented mainly as a multi-core processor, a network processor, or the like.

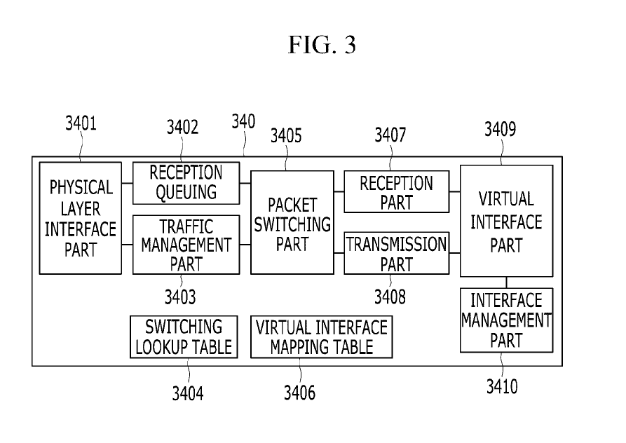

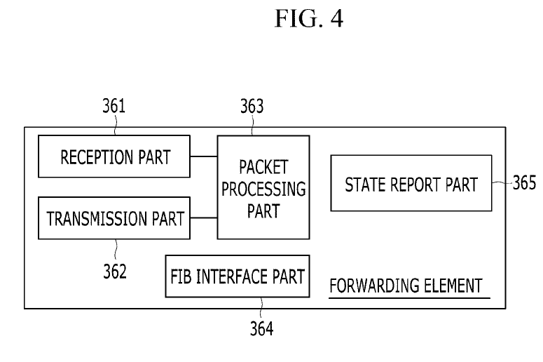

FIG. 3 is a view illustrating the VS depicted in FIG. 2, and FIG. 4 is a view illustrating the forwarding element depicted in FIG. 2.

Referring to FIG. 3, the VS 340 includes a physical layer interface part 3401, a reception queuing 3402, a traffic management part 3403, a switching lookup table 3404, a packet switching part 3405, a virtual interface mapping table 3406, a reception part 3407, a transmission part 3408, a virtual interface part 3409, and an interface management part 3410.

The physical layer interface part 3401 transmits packets by interworking with the physical layer interface part 310.

The reception queuing 3402 performs polishing functions such as packet discard indication, packet discard, or the like, and stores received packets, according to a QoS management policy.

The traffic management part 3403 performs scheduling or shaping upon packets to be transmitted to an external network according to the QoS management policy.

The switching lookup table 3404 stores virtualization routing information for packet switching in the form of a table.

The packet switching part 3405 performs the function of switching packets by referring to the switching lookup table 3404 and the virtual interface mapping table 3406.

The virtual interface mapping table 3406 stores information for mapping packets to a virtual interface in the form of a table.

The reception part 3407 receives packets from the forwarding elements FE0 to FEn, and forwards the received packets to the switching part 3405.

The transmission part 3408 transmits packets, switched by the packet switching part 3405, to a corresponding one of the forwarding elements FE0 to FEn.

The virtual interface part 3409 provides an interface between the VS 340 and the forwarding elements FE0 to FEn.

The interface management part 3410 performs the management of a virtual interface such as the generation and deletion of a virtual interface.

Referring to FIG. 4, each of the forwarding elements FE0 to FEn includes a reception part 361, a transmission part 362, a packet processing part 363, an FIB interface part 364, and a state report part 365.

The reception part 361 receives packets through the virtual interface part 3409 of the VS 340, and manages a reception buffer (not shown) through the MEA 330.

The transmission part 362 manages a transmission buffer (not shown) through the MEA 330, and transmits packets to the VS 340.

The packet processing part 363 generates packets to be transmitted to the outside, and processes received packets. The packet processing part 363 is configured to be programmable. For example, the packet processing part 363 may generate a packet to be reported to the MEA 330 by the state report part 365.

The FIB interface part 364 provides an interface with the FIB 350 storing the packet forwarding information.

The state report part 365 collects and manages the states of the corresponding forwarding elements FE0 to FEn, and the states of physical links and logical links, and reports this to the MEA 330. That is, the state report part 365 performs functions to provide an interface with the MEA 330, manage the state table of the corresponding forwarding elements (FE0 to FEn), report failure, and apply recovery.

The forwarding elements FE0 to FEn may further include function blocks for performing an interface function with the CEA 320 and the MEA 330.

According to an exemplary embodiment of the present invention, a control plane and a management plane existing in network equipment, and a data plane for packet transmission are separated. Thus, a control plane function such as calculating a routing path or the like is performed, reflecting a management policy, desired by a network operator, by a server within the separated control plane, and the result thereof is set in the network equipment by using a communication protocol, thus overcoming the drawbacks, such as complicated equipment functions, and difficulties in managing the control plane function of the equipment and in reflecting the management policy desired by the network operator.

Furthermore, by separating the control plane from a router and a switch, the network equipment can be simplified, and an operator can easily apply a new control plane algorithm, and the integrated management of functions for virtualizing physical resources of the network equipment can be carried out. Accordingly, the efficiency of the network equipment can be maximized and various user demands can be met at the same time.

The above exemplary embodiment of the present invention may be implemented by a program realizing functions corresponding to the construction of the exemplary embodiment, or a recording medium recording the program, rather than the apparatus and/or method described above. This implementation would easily be made from the disclosure of the exemplary embodiment by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for managing a virtual network, the apparatus comprising:
a network element performing a virtual routing function; and
a control management system performing functions of a control plane and a management plane of the network element, and separated from the network element.

2. The apparatus of claim 1, wherein the network element comprises:
a plurality of forwarding elements forwarding a packet;
a control element agent controlling the plurality of forwarding elements through communication with the control management system;
a management element agent managing the plurality of forwarding elements through communication with the control management system; and
a virtualization switch virtualizing and switching a packet received through the control management system, and virtualizing and switching a packet received from the plurality of forwarding elements.

3. The apparatus of claim 2, wherein the network element further comprises a forwarding information database storing packet forwarding information used as reference in forwarding the packet in the plurality of forwarding elements.

4. The apparatus of claim 2, wherein the virtualization switch comprises:
a switching lookup table storing virtualization routing information;
a virtual interface mapping table storing mapping information for mapping a packet to a virtual interface; and
a packet switching part switching a received packet by referring to the the switching lookup table and the virtual interface mapping table.

5. The apparatus of claim 4, wherein the virtualization switch comprises:
a virtual interface part providing a virtual interface with the plurality of forwarding elements; and
an interface management part generating and deleting the virtual interface.

6. The apparatus of claim 2, wherein each of the plurality of forwarding elements comprises:
a transmission/reception part transmitting/receiving a packet with the virtualization switch; and
a state report part reporting states of the plurality of forwarding elements, and states of a physical link and a logical link to the control management system.

7. The apparatus of claim 1, wherein the control management system comprises:
a control element manager generating a control element and controlling the network element; and
a management element manager generating a management element and managing the network element.

8. An apparatus for managing a virtual network, the apparatus comprising:
a plurality of forwarding elements forwarding a packet;
a physical layer interface part for communication with a control management system performing functions of a control plane and a management plane of a network element;
a control element agent controlling the plurality of forwarding elements through a control element generated by the control management system; and
a management element agent managing the plurality of forwarding elements through a management element generated by the control management system.

9. The apparatus of claim 8, further comprising a virtualization switch virtualizing a packet received through the control management system and switching the packet to a corresponding forwarding element of the plurality of forwarding elements, and virtualizing a packet received from the plurality of forwarding elements and switching the packet to the control management system.

10. The apparatus of claim 8, wherein the plurality of forwarding elements respectively report states of the plurality of forwarding elements, and states of a physical link and a logical link to control management system through the virtualization switch.
